(19) United States
(12) Patent Application Publication
(10) Pub. No.: US 2019/0170330 A1
(43) Pub. Date: Jun. 6, 2019

(54) A MULTISOURCE BEAM SHAPING SYSTEM

(71) Applicant: Robe Lighting s.r.o., Roznov pod Radhostem (CZ)

(72) Inventors: Pavel JURIK, Prostredni Becva (CZ); Josef VALCHAR, Prostredni Becva (CZ)

(21) Appl. No.: 14/386,316

(22) PCT Filed: Mar. 18, 2013
(86) PCT No.: PCT/US13/32850

§ 371 Date: Sep. 18, 2014

Related U.S. Application Data
(60) Provisional application No. 61/612,374, filed on Mar. 18, 2012.

(51) Int. Cl. F21V 14/06; F21V 5/04; F21V 17/02; F21V 23/04

(52) U.S. Cl. CPC F21V 14/06; F21V 5/04; F21W 2131/406; F21V 23/0435; F21V 17/02

(57) ABSTRACT

Described are improved automated multisource LED array luminaire with an array-wide, rotating beam shaper.

### RELATED APPLICATION

This application is a utility application claiming priority of United States provisional application with the same title Ser. No. 61/612,374 filed on 18 Mar. 2012.

### TECHNICAL FIELD OF THE INVENTION

The present invention generally relates to automated luminaire(s), specifically to a beam shaper for use with an automated luminaire(s).

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the ColorSpot 700E are typical of the art.

The optical systems of such luminaires may include a beam shaping optical element through which the light is constrained to pass. A beam shaping element may comprise an asymmetric or lenticular lens or collection of lenses that constrain a light beam that is symmetrical and circular in cross section to one that is asymmetrical and predominantly elliptical or rectangular in cross section. A prior art automated luminaire may contain a plurality of such beam shapers each of which may have a greater or lesser effect on the light beam and that may be overlapped to produce a composite effect. For example a weak beam shaper may constrain a circular beam that has a symmetrical beam angle of 20° in all directions into a primarily elliptical beam that has a major axis of 30° and a minor axis of 15°. A more powerful beam shaper may constrain a circular beam that has a symmetrical beam angle of 20° in all directions into a primarily elliptical beam that has a major axis of 40° and a minor axis of 10°. It is also common in prior art luminaires to provide the ability to rotate the beam shaper along the optical axis such that the resultant symmetrical elliptical beam may also be rotated. U.S. Pat. Nos. 5,665,305; 5,758,955; 5,980,066 and 6,048,080 disclose such a system where a plurality of discrete lens elements is used to control the shape of a light beam.

FIG. 1 illustrates a multiparameter automated luminaire system 10. These systems commonly include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15.

Prior art beam shapers often require installation internally within the luminaire and are not suitable for optical systems where an array of a number of discrete emitters, such as LEDs, is used to produce the beam. Instead they rely on the optical path having a focus point that is small compared to the overall diameter of the beam in which the beam shaping can be situated.

There is a need for an improved beam shaper mechanism for automated luminaires that is simple to install or remove from a luminaire, which provides the ability to smoothly and continuously adjust the angle of eccentricity of the constrained light beam for a light beam produced by an array of discrete emitters such as LEDs.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates an embodiment of the beam shaping system mounted to an automated luminaire;

FIG. 3 illustrates a cross sectional view of the beam shaping system mounted to an automated luminaire;

FIG. 4 illustrates a light beam after modulation by a beam shaper;

FIG. 5 illustrates a light beam after modulation by a beam shaper;

FIG. 6 illustrates an embodiment of the beam shaping system;

FIG. 7 illustrates an embodiment of the beam shaping system;

FIG. 8 illustrates an embodiment of the beam shaping system;

FIG. 9 illustrates an embodiment of the beam shaping system mounted to an automated luminaire;

FIG. 10 illustrates an elevation view of an embodiment of the beam shaping system mounted to an automated luminaire, and;

FIGS. 11-16 illustrate embodiments of the beam shaper.

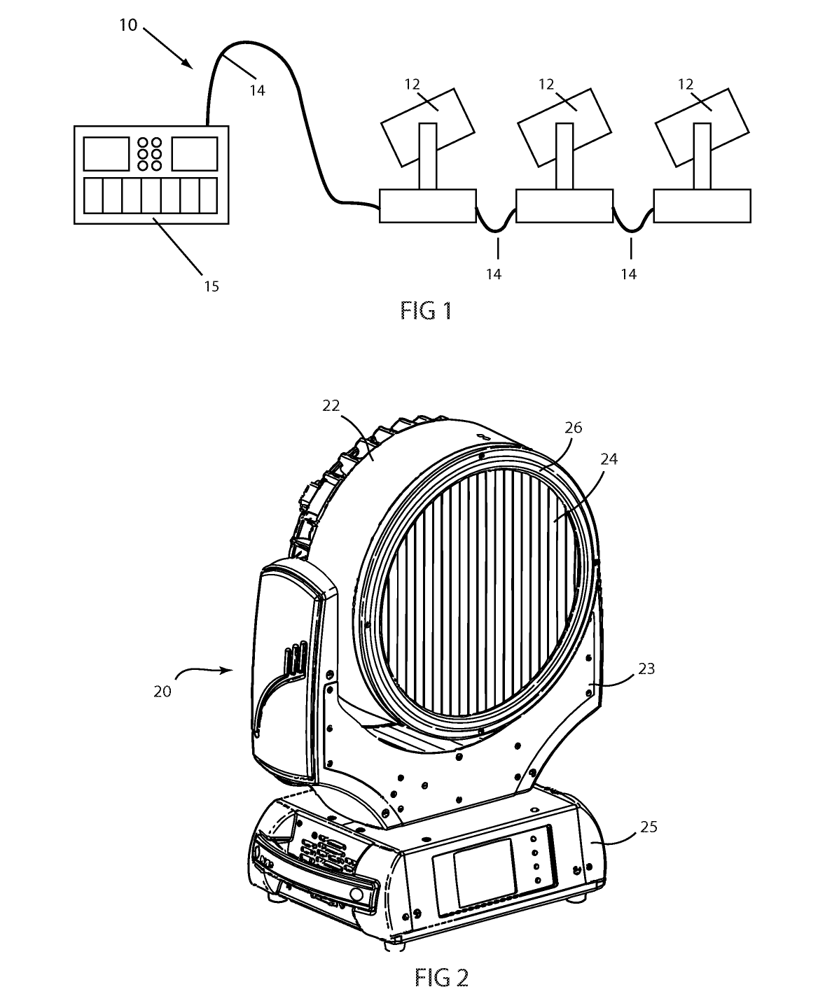

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to the configuration of a beam shaper within such a luminaire such that it provides the ability to adjust the size or eccentricity of the constrained light beam.

FIG. 2 illustrates an embodiment of the beam shaping system mounted to an automated luminaire. Automated luminaire 20 comprises base box 25 on which is rotatably mounted yoke assembly 23 which is able to rotate in a first axis relative to base box 25. Luminaire head 22 is rotatably mounted to yoke 23 and is able to rotate in a second axis relative to yoke 23. Beam shaper 24 is mounted in rotatable frame 26 to the front of luminaire head 22. Beam shaper 24 may be rotated around the optical axis of luminaire head 22.

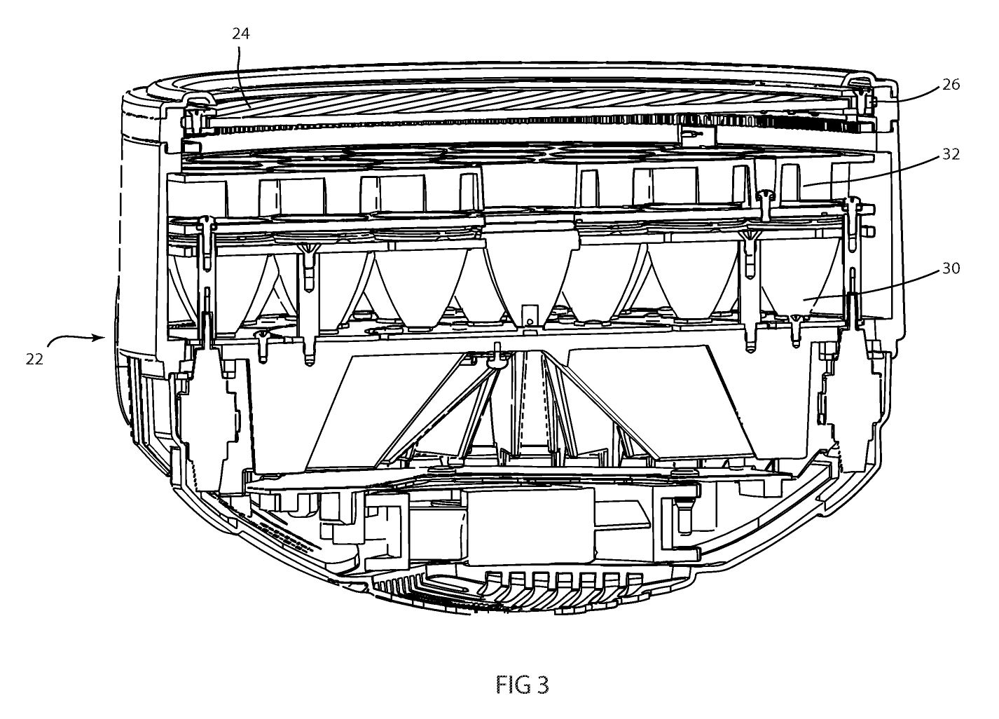

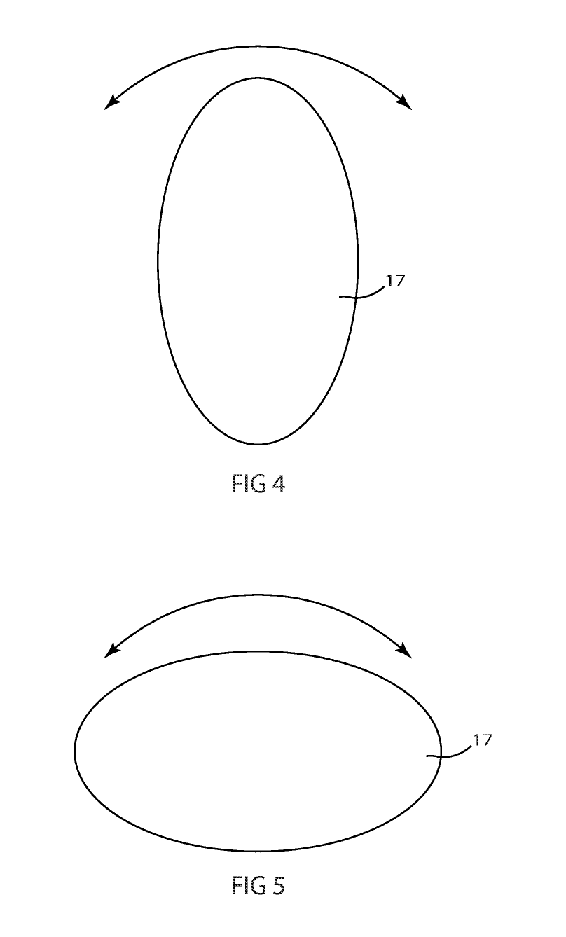

FIG. 3 illustrates a cross sectional view through luminaire head 22. An array of discrete LED emitters 30 and their associated individual optical systems 32 produce multiple beams of light each of which passes through beam shaper 24. Transmissive beam shaper 24 is mounted in rotatable frame 26 to the front of luminaire head 22. Beam shaper 24 may be rotated around the optical axis of luminaire head 22. In one embodiment, beam shaper 24 may comprise a disk of optically transparent material such as glass, acrylic, or polycarbonate that is embossed or molded with a pattern or array of raised or lowered linear areas to form an array of ribbed or lenticular lenses. When the substantially circular light beam passes through this ribbed or lenticular lens the cross section of that beam will be constrained to a cross section 17 that is asymmetrical and predominantly elliptical or rectangular in shape as shown in FIG. 4. Such a system may be rotated around an axis parallel with the optical axis of the luminaire to rotate the elliptical beam shown in FIG. 4 to the position shown in FIG. 5. The beam shaper 24 may be continuously rotated a full 360° to produce any intermediate result. The user may choose and replace beam shaper 24 with different beam shapers that produce different results in the output beam. For example, beam shapers that produce light beams with a greater or smaller eccentricity angle, asymmetric beam shapers that affect the beam in just one direction, prismatic beam shapers, diffusion beam shapers, holographic beam shapers, lenslet beam shapers, or other beam shapers as known in the art. The system could also be used as a beam diverter using a beam shaper that deflects the light axis through an angle.

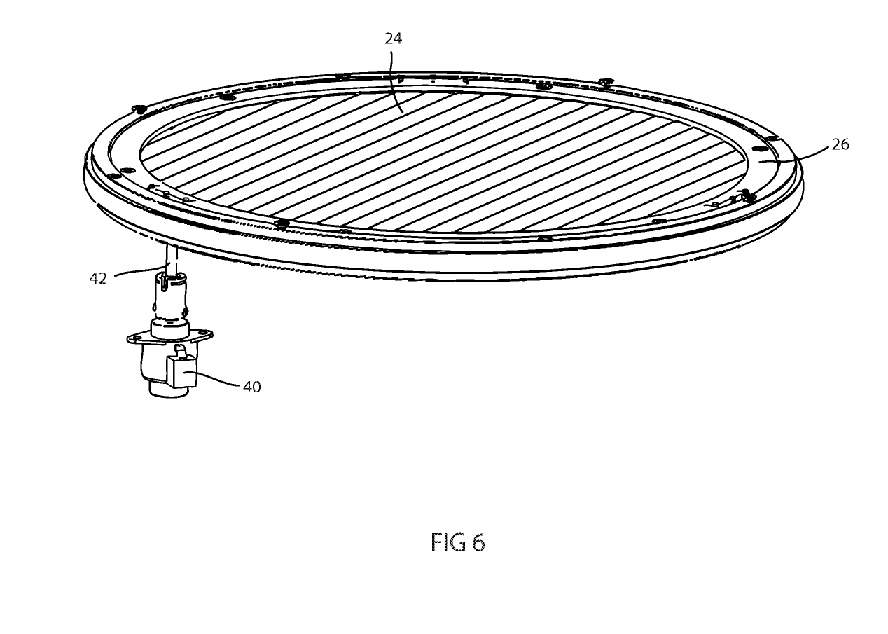

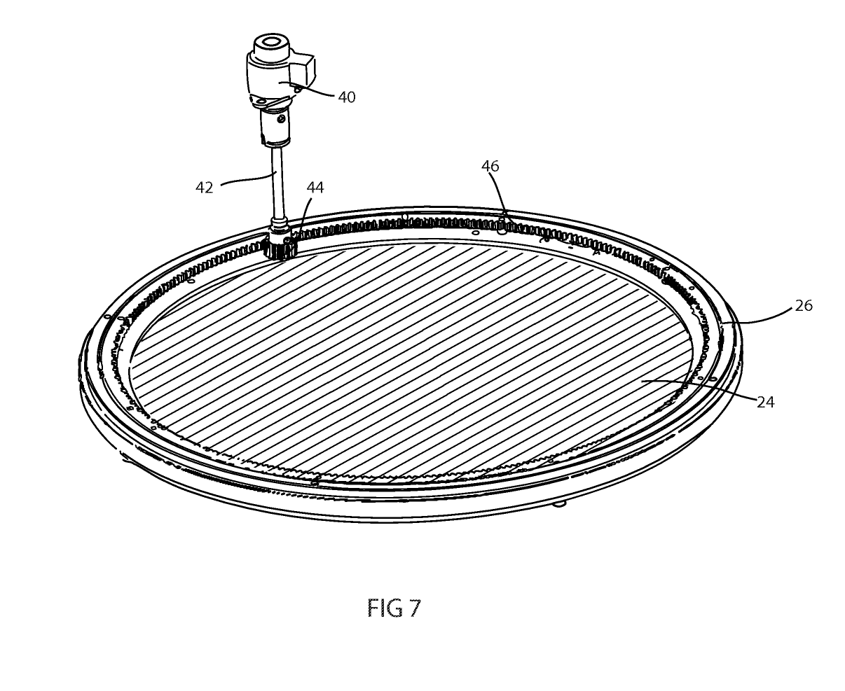

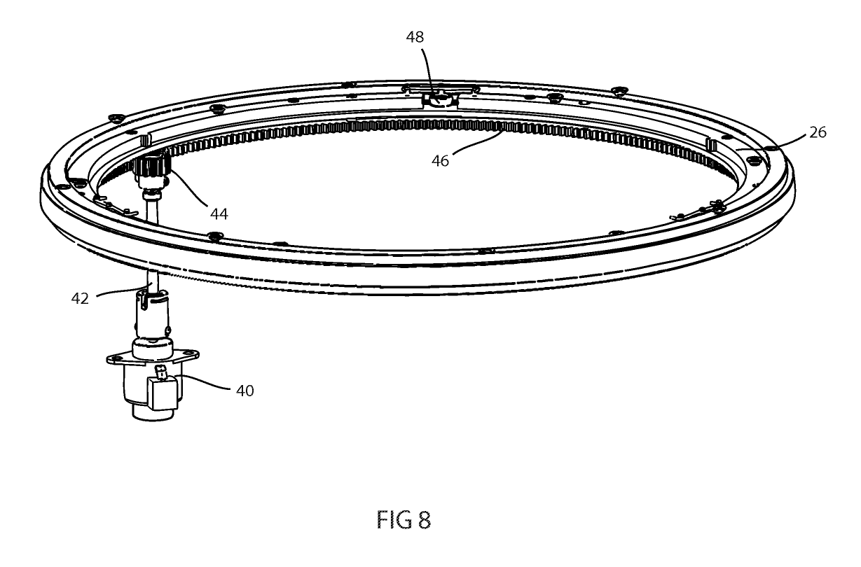

FIGS. 6, 7 and 8 illustrate an embodiment of the beam shaper system removed from the luminaire for clarity. Beam shaper 24 is mounted within rotatable frame 26. Motor 40 drives shaft 42 and thus pinion gear 44. Pinion gear 44 in turn engages with and drives ring gear 46 which is part of rotatable frame 26. Rotatable frame 26 is free to rotate within bearings 48 that are mounted to fixed frame 27. Because of the large gear ratio between pinion gear 44 and ring gear 46, rotatable frame 26 may be rotated smoothly and positioned accurately. Motor 40 may be a stepper motor, or other motor known in the art such as a servo motor.

FIGS. 9 and 10 illustrate an embodiment of the beam shaper as mounted to an automated luminaire. In this figure the beam shaper 24 is omitted to allow the construction to be seen. Pinion gear 44 engages with and drives ring gear 46 so as to rotate the beam shaper (omitted for clarity) in front of the array of LED output optics 32. Pinion gear 44 is small and does not materially interfere with the light beam from adjacent emitters, nor does the system cause any appreciable increase in the size of the automated luminaire. Such a system is extremely flexible, its position on the outside front of the automated luminaire makes it simple for eh user to change the beam shaper to any design that they wish to achieve the desired effect. Alternatively, it can easily be completely removed to allow the system to revert back to its native beam shape.

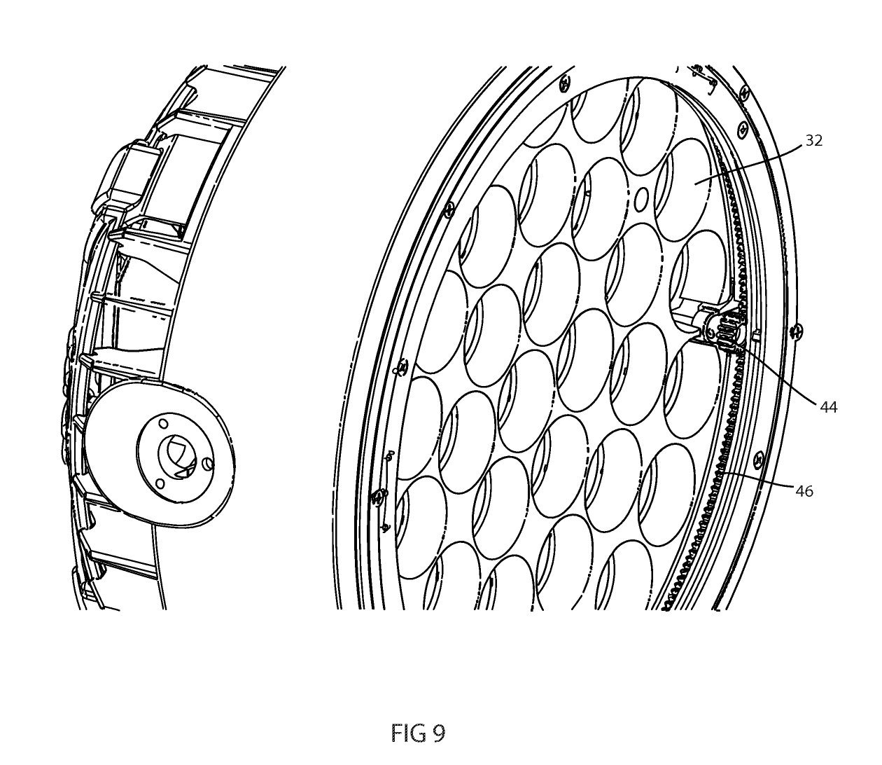

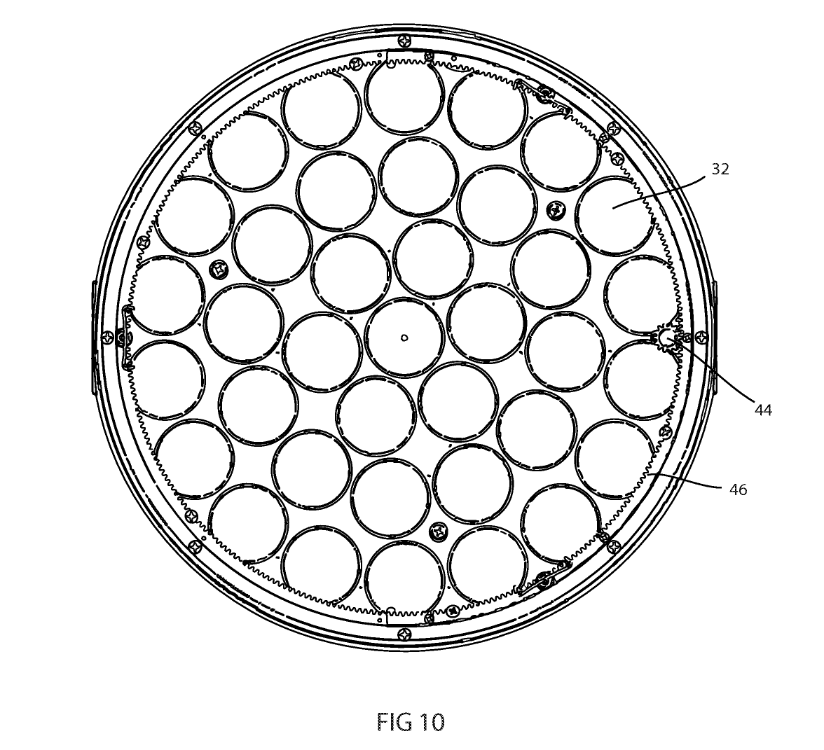

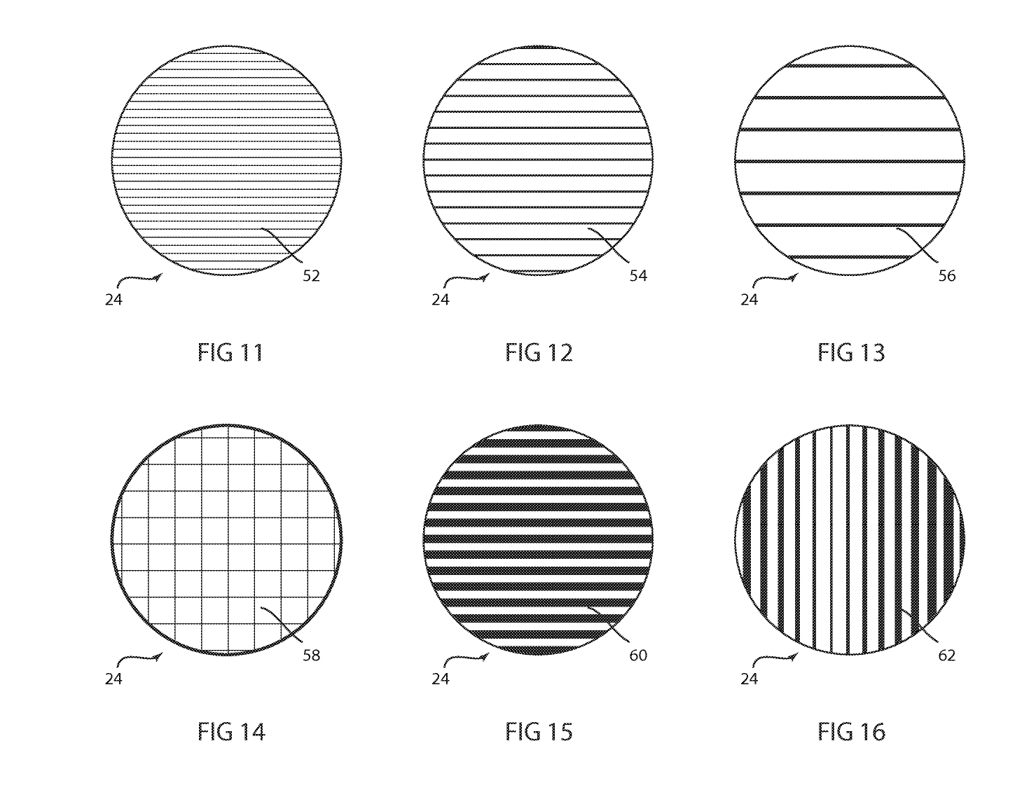

FIGS. 11-16 show embodiments of beam shaper 24. FIGS. 11, 12 and 13 represent differing angles of beam shaper where 52 may be a wide angle asymmetric lens array, 54 is a medium angle asymmetric lens array and 56 is a narrow angle asymmetric lens array. FIGS. 14, 15 and 16 are examples of different beam shapers that may be used. 58 is a grid array of lenticular lenses, 60 is a linear array of prisms forming an offset beam, 56 is a linear array of random angle prisms forming a complex asymmetric beam. In every case beam shaper 24 may be rotated so as to rotate the effect produced.

In an alternative embodiment (not shown) the beam shaper 24 could be a portion of a disc instead of a full disc so that it only covers and affects a proportion of the LEDs.

It should be appreciated that in any cases where articulation of elements is called for herein but not shown, it is well within the known art to provide a variety of mechanisms that can achieve these necessary articulations.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

1. An automated luminaire comprising:
a plurality of light sources configured in a multisource array to form a light beam; and
a rotatable transmissive beam shaper spanning the multisource array.

2. The automated luminaire of claim 1 where the plurality of light sources in the multisource array are LEDs

3. The automated luminaire of claim 1 where the rotation of the transmissive beam shaper is automated for remote control operation.

4. The automated luminaire of claim 1 where the transmissive beam shaper only covers a portion of the multisource array.

5. The automated luminaire of claim 1 where the transmissive beam shaper is a lenticular lens whereby the beam is reshaped by elongation along one axis.

6. The automated luminaire of claim 1 where the transmissive beam shaper is a an linear array of prisms whereby the beam an offset beam(s) the effect of which changes as it rotates.

7. The automated luminaire of claim 6 where the transmissive beam shaper is a linear array of prisms with varying angles.

8. The automated luminaire of claim 1 where the transmissive beam shaper is a non-linear array of prisms.
